(19) United States
(12) Patent Application Publication
(10) Pub. No.: US 2003/0154285 A1
(43) Pub. Date: Aug. 14, 2003

(54) Method and system for assigning network addreses

(75) Inventors: Neil Clair Berglund, Mantorville, MN (US); Steven Dean Devinny, Rochester, MN (US); Thomas James Osten, Rochester, MN (US); Lee Anton Sendelbach, Rochester, MN (US)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 10/074,574

(22) Filed: Feb. 13, 2002

(51) Int. Cl. G06F 15/16

(52) U.S. Cl. 709/227; 709/208

(57) ABSTRACT

A method and system for using an Ethernet ring topology to connect Ethernet Computer Enclosure Services (CES) devices. The system contains two physical Ethernet tailstock connectors for every CES device on the Ethernet ring for point-to-point connection between Ethernet Network Interface Cards (NIC's) connected to each CES device. A master CES device initiates all network traffic, and the master CES device assigns IP addresses for all CES devices, including both the master CES device as well as slave CES devices on the Ethernet ring. After IP addresses are assigned to all CES devices, a network command is issued by the master CES device on a regular basis to poll the slave CES devices for status and failure information. If a break occurs anywhere in the ring, the master CES device isolates and identifies the break and reverses the direction of the polling signal to access each slave CES device.

### BACKGROUND OF THE INVENTION

1. Technical Field

The present invention relates in general to the field of computers, and in particular, to computer networks having multiple computer nodes. Still more particularly, the present invention relates to an improved method and system for assigning Transmission Control Protocol/Internet Protocol (TCP/IP) addresses to the computer nodes on an Ethernet for providing Computer Enclosure Services (CES) to the computer nodes.

2. Description of the Related Art

Methods and systems for providing monitor, control and diagnostic services commonly referred to as Computer Enclosure Services (CES) are known in the prior art. CES defines a computer's common control mechanisms and/or sensors that are not normally directly associated with a Central Electronic Compartment (CEC), which includes a main host processor and a main host memory. Examples of CES equipment and networks include power supplies, cooling systems (fans), operation control panels and vital product data (VPD) identifying components by manufacturer, serial number, part number, etc., as well as Interbox and Intrabox communication buses (e.g., Recommended Standard 485 (RS-485) and Inter-Integrated Circuit (12C) respectively). Traditionally, box-to-box (Interbox) CES networks have used RS-485 compliant connectors, using the Electronics Industry Association (EIA) standard for multipoint communications. While RS-485 interfaces support several types of connectors, including DB-9 and DB-37, and multiple nodes per line using low-impedance drivers and receivers, their signaling is slow and requires proprietary networking stacks (protocols) to implement CES functions.

Three typical interfaces used in the computer industry for implementing CES are RS-485 interfaces, modems and Ethernets. RS-485 interfaces are limited as described above. Modems are useful for data collection from a remote Internet portal, but are not designed for handling tightly integrated enclosure services due to hardware requirements and relative slow performance. Thus, Ethernet interfaces provide a preferable interface for implementing CES. In the prior art, Ethernet interfaces are primarily connected via two network topologies: Multi-drop and Star.

Multi-drop network topologies utilize a bus topology as illustrated in FIG. 1a. The most common example of this topology uses a coaxial cable 10 to serve as a bus with a maximum data bandwidth of 10 Mbps for cable 10, which includes 10Base-5 (capable of transmitting data up to 500 meters) or 10Base-2 (capable of transmitting data up to 185 meters). Connected to cable 10 are multiple computer boxes, typically Personal Computers (PCs), such as computer boxes 14, 16 and 18. Computer boxes 14, 16 and 18 connect to cable 10 via BNC T-connectors and short pieces of the same type of coaxial cable used for cable 10. At the end of cable 10 are terminators, which connect an appropriate resistor between the center conductor and the shield of the coaxial cable making up cable 10 to prevent signal reflection back along cable 10. Multi-drop Ethernet topologies are not an acceptable CES connection for robust server applications, since a wiring fault on cable 10 can potentially terminate communications to all computer boxes 14, 16, and 18 connected to cable 10.

Star network topologies, as depicted in FIG. 1b, typically use unshielded twisted pairs (UTP) of copper wires to convey differential signals between a hub 20 and multiple computer boxes such as computer boxes 22, 24 and 26. When using copper wires, this topology is referred to as a Base-T, and when using optical fiber is referred to as a Base-F. The speed of the data bandwidth across wires or optical fibers ranges from 10 Mbps to 100 Mbps to 1000 Mbps (1 Gbps), and thus for copper wiring such topologies are called 10Base-T, 100Base-T and 1000Base-T.

Star network topologies are not desirable for CES connections for several reasons. First, a star network requires a separate piece of hardware in hub 20. This adds expense to the system, and poses the problem of where to physically place hub 20. Next, the number of computer to be connected must be known prior to attaching to hub 20 because hub 20 is a 1-to-N connection box. The number of physical port connects N must match the expected maximum number of computers connected. If a small hub was purchased to match the initial requirements, the small hub must be dealt with as the network grows. Old hubs are either thrown out and replaced or they are left in the network to be connected in a tree fashion. If left in the network as part of a tree, the number of hubs begin to multiply, and Institute of Electrical and Electronic Engineers (IEEE) specifications and standard on the number of hubs per network can easily be violated. Further, hub connections invite unwanted pluggable access into what would otherwise be a more private network, thus requiring more sophisticated access control and security. In addition, if dual-Ethernet connections are desired for redundancy (no single-point-of-fail), then the number of hubs (and the number of hub ports) doubles. Finally, without separate service interfaces and manual interventions, hud 20 provides no view of cabling topology. That is, there is no physical/tangible correlation between the socketed Media Access Control-Internet Protocol (MAC-IP) address/port and the physical Ethernet connection used on hub 20. One of the primary design requirements for a system's CES connections is that they be point-to-point. That is, each Field Replaceable Unit (FRU) within a robust server platform must be able to be “located” starting with its physical connector socket; to the backplate it is plugged into; to the drawer/tower in which it resides; and to the rack that may hold the drawer/tower. For many CES server applications, this discovery of packaging hierarchy must be established automatically (i.e., without human intervention). Thus, while Ethernet is designed for its speed and small connector footprint, hub 20 is not an acceptable implementation for CES connections.

If redundancy is required in a star network configuration, a redundant topology such as depicted in FIG. 1c must be utilized. A first hub 36 and a second hub 38 are connected to a Bootstrap Protocol (BootP) or Dynamic Host Configuration Protocol (DHCP) master computer box 40 as well as several slave computer boxes 42a-c. Each computer box (master and slave) has a first port connected to first hub 36 and a second port connected to second hub 38. If either hub fails, or if a line from one of the hubs to one of the computer boxes breaks, the redundant connection from the other hub is used.

Another network topology is the Hirschmann Ethernet Ring, depicted in FIG. 1d, developed by Hirschmann Network Systems of Hirschmann Rheinmetall Elektronik. The Hirschmann Ethernet Ring has a redundancy manager 30 that includes a logical break 32. Redundancy manager 30 is connected in serial fashion to multiple Ethernet switches 34. Ethernet switches 34 are expensive “smart-hubs” that run a full TCP/IP software stack as well as Routing Information Protocol (RIP) or similar routing software code. Redundancy manager 30 is a “state-machine” that pings diagnostic messages around the loop back to redundancy manager 30 to sense if the loop is still intact. To prevent the queries from continuing to travel around the loop, logical break 32 in redundancy manager 30 stops the received ping query. If a break occurs between redundancy manager 30 and any one of Ethernet switches 34, a physical connection is completed within redundancy manager 30 to re-establish a logical and physical connection for any queued or subsequent Ethernet messages to any switch and device in the network. Such a break requires Ethernet switches 34 to update their routing tables to provide an alternate path around the break in the ring through redundancy manager 30.

Each CES node (e.g., a computer box) in an Ethernet network typically requires an Internet Protocol (IP) address in order to be accessed. In the prior art, this is accomplished using protocols such as BootP or DHCP. BootP is an Internet protocol that enables a diskless workstation to discover its own IP address, the IP address of a BootP server on the network, and a file to be loaded into memory to boot the machine, thus enabling the workstation to boot without requiring a hard or floppy disk drive. DHCP is a protocol for assigning dynamic IP addresses to devices on a network. With dynamic addressing, a device can have a different IP address every time the device is connected to the network. In some systems, the device's IP address can even change while the device is still connected. DHCP also supports a mix of static and dynamic IP addresses. Dynamic addressing simplifies network administration because the software keeps track of IP addresses rather than requiring an administrator to manage the task. This means that a new computer can be added to a network without the hassle of manually assigning the new computer a unique IP address. Many Internet Service Providers (ISP's) use dynamic IP addressing for dial-up users.

BootP and DHCP protocol based routines for initialization of IP addresses were primarily designed for multi-drop and star topologies, although they can be used with some point-to-point topologies, such as strings and loops. The BootP Relay program, for instance, when used with BootP or DHCP, allows IP addressing beyond the first point-to-point connected node. However, this program has the drawback of requiring slave nodes to initiate the request for their IP initialization (IP-Init) at power up. Upon receiving minimal (standby) direct current (dc) power from an alternating current (ac) source or a battery, BootP slaves (sometimes called “clients”) in a string topology issue a command (request) on either or both of its ports requesting a unique IP address from the first (master) BootP (or DHCP) server encountered based on the slave's 6-byte Medium Access Control (MAC) address, typically set by the manufacturer of the slave computer.

Under the Open System Interconnection (OSI) model for a networking framework for implementing protocols, there are seven layers through which control is passed, starting at the application layer (Layer 7) down to the physical layer (Layer 1). Just above the physical layer, which provides the hardware means of sending and receiving data on a carrier, including defining cables, cards and physical aspects, is the Data Link Layer (Layer 2). In Layer 2, data packets are encoded and decoded into bits, and transmission protocol knowledge and management is furnished. One of the sublayers in Layer 2 is the MAC sublayer, which controls how the computer on a network gains access to data and permission to transmit it, and thus requires the MAC address described above.

When using BootP or DHCP protocol based applications in a slave initiated IP address initialization on a point-to-point network, error recovery problems can be encountered due to the requirement that the request for an IP address is initiated by the slave node. In order to use existent BootP or DHCP methods in this environment, there are three approaches for error recovery and strategy during the IP initialization sequence.

First, the slaves sending the BootP/DHCP request can set up a software “do-loop” with a set time-out waiting for the server's response. If the time-out is reached, a branch posts the error to a local “operator-panel” or sets a local error indicator light. The problem with driving error indications locally from the slave is that these failures must be recognized manually at the location where each slave resides. There is also the problem that since the slave cannot properly and completely configure itself(using BootP or DHCP), it is severely limited in the amount of information it can provide to the local operator panel or modem to help tack down the offending node or cable. An application involving a modem also has the drawback of burdening every slave with this extra cost.

A second method of error recovery eliminates the slave's loop-timeout and error. However, this results in an aggravating interrupt to the adjacent nodes that must always service the interrupting message to attempt to relay the BootP/DHCP message even though a node downstream is causing the command/request to never be answered. This creates a distributed error recovery scenario where multiple slaves may be posting an error message indicating too many of these aggravating interrupts are occurring. This then compounds the manual discovery process as described above in the first method.

A third method is to force all platforms to always be configured as a ring so that slaves have the ability to “go-the-other-way” around the loop to request an IP address from their alternate port. While the odds are small, the possibility exists that this path may also be broken and the problems again reverts to those seen in methods one and two above. However, the larger problem with a ring connection compared with a drop-line configuration is that the customer is not allowed to designate one Ethernet port on the master node to service a string connected network, with the other port optionally being used to connect to a customer network for remote service or other administrative purposes. There is a penalty associated with certain low cost platforms since the only way to add a connection to a two-ported CES node in a ring configuration is to upgrade the CES node with a third Ethernet connection. If the CES node solution is a chipset, then three Ethernet connections are necessary. If the CES node supported a PCI bus, then a PCI-based Network Interface Card (NIC) is needed. If the CES node does not provide any feature to enable an internal connection to support a third Ethernet, then a specially designed and configured Ethernet switch is necessary. The Ethernet switch would have to support both normal private traffic around the ring as well as public traffic and to be able to distinguish between the two.

The above-mentioned problems associated with standard IP-initialization schemes (using BootP or DHCP) illustrate the limitation of their use, which is the lack of appropriate and standard error recovery software during the initialization process. Since a BootP (or DHCP) slave initiates the IP-Init sequence, the master server is unaware of the initialization traffic unless it succeeds in transversing all of the intermediary nodes. If a problem develops in these intermediate stages, the master node is unaware of the problem.

Therefore, there exists a need for a method that simplifies the structure for an Ethernet ring topology for CES environments, and provides IP addresses for each computer node on the Ethernet ring. Further, it would be desirable to devise a system using an improved Ethernet ring topology having the means to provide IP addresses for each computer node on the ring in a CES environment. In addition, it would also be desirable to devise a computer program product wherein such IP addresses are assigned and communication between computer nodes on the Ethernet ring is facilitated.

### SUMMARY OF THE INVENTION

The present invention is a method and system for using an Ethernet ring topology to connect Ethernet Computer Enclosure Services (CES) devices. The system contains two physical Ethernet tailstock connectors for every CES device on the Ethernet ring for point-to-point connection between Ethernet Network Interface Cards (NIC's) connected to each CES device. A master CES device initiates all network traffic, and the master CES device assigns IP addresses for all CES devices, including both the master CES device as well as slave CES devices on the Ethernet ring. After IP addresses are assigned to all CES devices, a network command is issued by the master CES device on a regular basis to poll the slave CES devices for status and failure information. If a break occurs anywhere in the ring, the master CES device isolates and identifies the break to a particular network segment, and alternately reverses the direction of the polling signal to access each slave CES device.

The above, as well as additional objectives, features, and advantages in the present invention will become apparent in the following detailed written description.

### BRIEF DESCRIPTION OF THE DRAWINGS

The novel features believed characteristic of the invention are set forth in the appended claims. The invention itself, however, as well as the preferred mode of use, objects and advantages thereof, will best be understood by reference to the following detailed description of an illustrative embodiment when read in conjunction with the accompanying drawings, wherein:

FIG. 1a depicts a prior art multi-drop Ethernet topology;

FIG. 1b illustrates a prior art star Ethernet topology;

FIG. 1c depicts a prior art start Ethernet topology with redundancy;

FIG. 1d illustrates a prior art ring Ethernet topology;

FIG. 2 is a block diagram of an inventive Ethernet ring topology used in the present invention;

FIG. 3 depicts schematically various software and associated hardware that are present in a preferred Computer Enclosure Services (CES) node used in an inventive Ethernet topology;

FIG. 4 illustrates additional detail of a preferred Transmission Control Protocol/Internet Protocol (TCP/IP) software stack in the CES node;

FIG. 5 depicts a reduced software stack used in a CES node associated with an alternate less expensive microprocessor;

FIG. 6 illustrates a preferred embodiment of a system power control network (SPCN) command packet encapsulated in user datagram protocol (UDP) and IP packets for transmission via the Ethernet;

FIG. 7 is a flow chart depicting a preferred embodiment for assigning new IP addresses in an Ethernet topology;

FIGS. 8 and 9 illustrate an Ethernet topology having a master computer and five slave computers, each computer having a CES node;

FIG. 10 depicts a four node Ethernet ring having factory set default IP addresses for CES node ports; and

FIGS. 11 and 12 illustrate a reassignment of node IP addresses using the present invention.

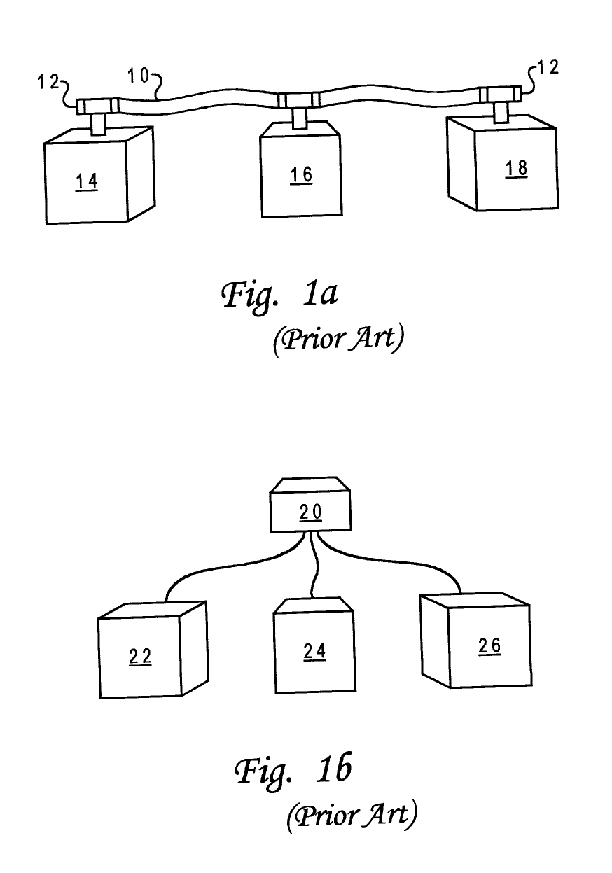

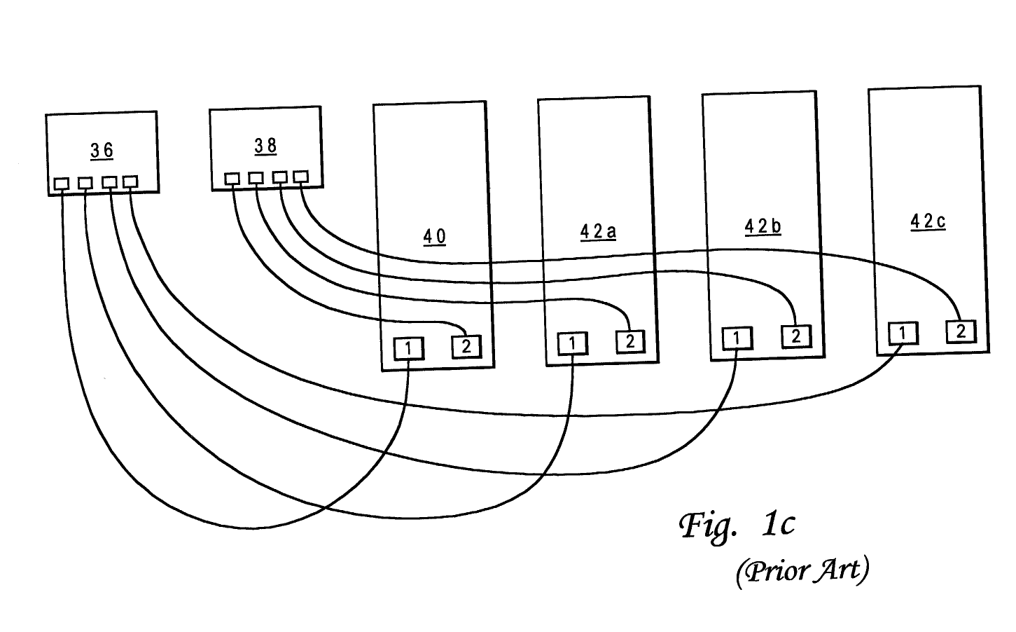

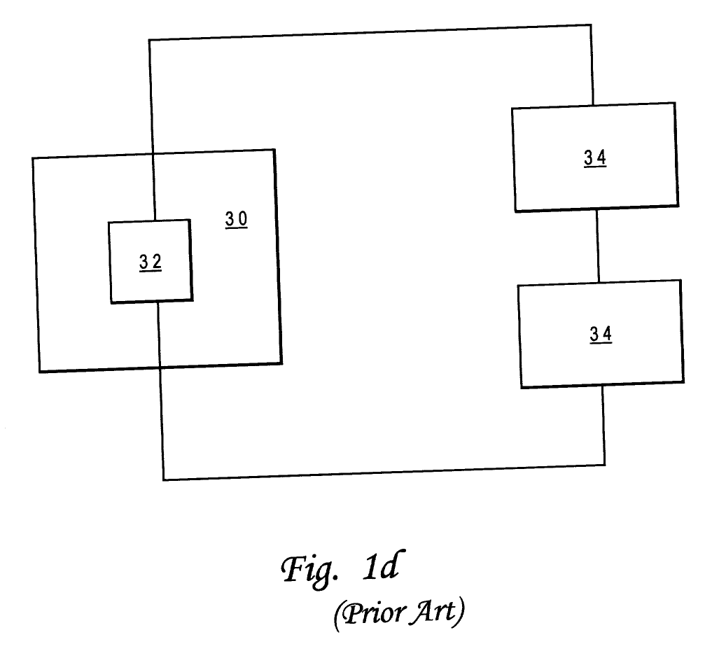

### DETAILED DESCRIPTION OF THE PREFERRED EMBODIMENT

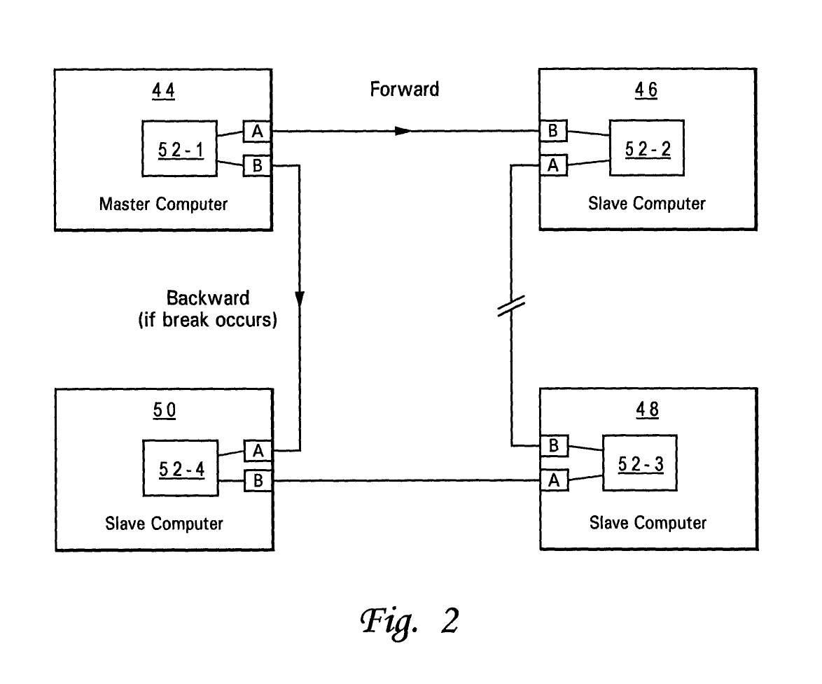

With reference now to FIG. 2, there is represented a block diagram of an Ethernet ring topology used in the present invention. As will be more fully explained below, the ring topology is a preferred embodiment because of its ability to provide redundancy to components in the ring. However, the present invention may also be practiced in a string topology, but without the inherent redundancy protection of the ring topology. In the preferred Ethernet topology, there is a master computer 44 and multiple slave computers, showing in FIG. 2 as being three in number and denoted as a slave computer 46, a slave computer 48, and a slave computer 50. The computers are preferably connected as depicted with differential pair signal lines connecting computer enclosure service (CES) nodes 52. Each computer has a CES node 52, which is described in more detail below. Each CES node 52 has a port A and port B. In a preferred embodiment, port A and port B are associated with a network interface card (NIC) (not shown) connected to each computer. The NICs are capable of transceiving information between computers. It is understood that an NIC is a generic term that does not necessarily imply a physical “card.” For example, the NIC may be an embedded module or an embedded chipset (not pluggable into the computers).

In a preferred embodiment shown in FIG. 2, CES node 52-1 of master computer 44 transmits through port A a signal to receiving port B of CES node 52-2 of slave computer 46. CES node 52-2 of slave computer 46 then transmits, via its port A, a signal to slave computer 48, via port B of CES node 52-3 of slave computer 48. The communication continues in a circular fashion from master computer 44 through slave computer 46, to slave computer 48, to slave computer 50, and then back to master computer 44. If a break occurs in the loop, master computer 44, functioning as a dual-homed host, redirect signals to travel in an opposite direction in the ring. In the example shown in FIG. 2, the signal is transmitted via port B of CES node 52-1 of master computer 44 to receiving port A of CES node 52-4 of slave computer 50. With the break in communication lines being shown between slave computer 46 and slave computer 48, master computer 44 is able to communicate with slave computer 46 by establishing a first network via master computer 44's port A. Master computer 44 is able to communicate via a second home network by directing signals through port B of CES node 52-1 of master computer 44. Signals are transmitted via port B of master computer 44 to receiving port A of CES node 52-4 of slave computer 50, and the signal is passed through as described in more detail below, through subsequent ports and CES nodes as depicted in FIG. 2.

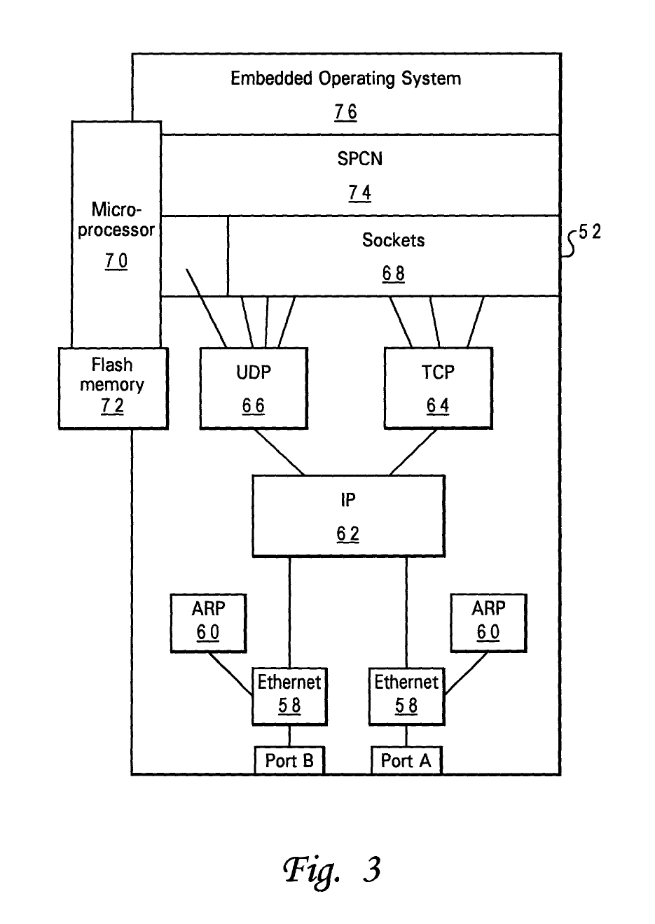

As illustrated in FIG. 3, a preferred embodiment of CES nodes 52 include multiple software layers. FIG. 3 is a schematic representation of the interaction of the software and associated hardware. Port A and port B, associated with an NIC (not shown), provide communication associated with the Ethernet addresses depicted as Ethernet software 58. Associated with Ethernet software 58 is address resolution protocol (ARP) 60. ARP 60 represents software associated with the protocol for using transmission control protocol/Internet protocol (TCP/IP) protocol used to convert an Internet protocol (IP) address into a physical address represented as Ethernet software 58. In an Ethernet environment, a host computer wishing to obtain a physical address broadcasts across the Ethernet an ARP request into the TCP/IP network. The computer on the network that has the IP address in the request then replies to the host with its physical hardware address, and the IP address is represented as block IP 62.

IP 62 can access higher order software described below either through TCP, as depicted in block 64, or through user datagram protocol (UDP), as depicted in block 66. UDP and TCP both run on top of the IP stack. Unlike TCP/IP, UDP/IP provides limited error recovery services. Under TCP/IP, delivery of data in the same order in which they were sent is guaranteed by the error detecting protocol of TCP. UDP/IP however, instead offers only a direct way to send and receive datagram packets of messages being transmitted over the network. The datagram packet, including both the destination IP address as well as the data, is sent to the target computer, but under UDP/IP does not establish a connection between the sender and receiver that establishes transmission confirmation.

Above the UDP or TCP stack are sockets, depicted as sockets 68. The sockets are a software object that connect an application to a network protocol. In a UNIX environment, an application such as system power control network (SPCN), discussed further below, connects the network protocol of either UDP/IP or TCP/IP. In units, for example, the SPCN program can send and receive TCP/IP or UDP/IP messages by opening the software socket or port and reading and writing data to and from the socket (or port). When using UDP/IP, the connection can be made without a socket as discussed in more detail below.

Above the socket layer and/or the UDP/IP layer is an application software. In a preferred embodiment, this application software is SPCN as depicted as SPCN 74 of FIG. 3. However, any standard application software may be used with the present invention, including, but not limited to, Inter-IC (12C) bus based Intelligent Platform Management Interface (IPMI), Hyper Text Markup Language (HTML) language, etc. In the preferred mode, however, SPCN is used as a controlling application software. SPCN is described in further detail in U.S. Pat. No. 5,935,252 and U.S. Pat. No. 5,117,430, which are incorporated by reference herein. SPCN controls power and cooling for the computer system and can also selectively apply power to vital product data (VPD) chips, which contain information regarding equipment, such as the manufacturer, model number, serial number, etc. From the VPD chip (not shown), the SPCN can read the power configuration data before power is applied to the rest of the computer system. This provides the ability to configure the power and cooling system and make any critical checks before power is applied to the entire computer system, thereby avoiding the risk of damaging the computer system components through the application of incorrect voltages or insufficient cooling, for example. In addition, SPCN, reading data from the VPD chips, can be used to associate power systems with cooling speeds, power sequencing requirements, processor type and cash voltage requirements, etc. In the present invention, however, SPCN or a similar application program is used to communicate with the Ethernet NIC transceivers, associated with port A and port B of each CES node 52. Sitting above the SPCN software layer is an embedded operating system, depicted as operating system 76. The embedded operating system operates within microprocessor 70, which includes its associated flash memory 72, as schematically illustrated in FIG. 3. The embedded operating system allows microprocessor 70 to control the operations of the SPCN and the UDP/IP or TCP/IP protocol communicating with Ethernet software 58.

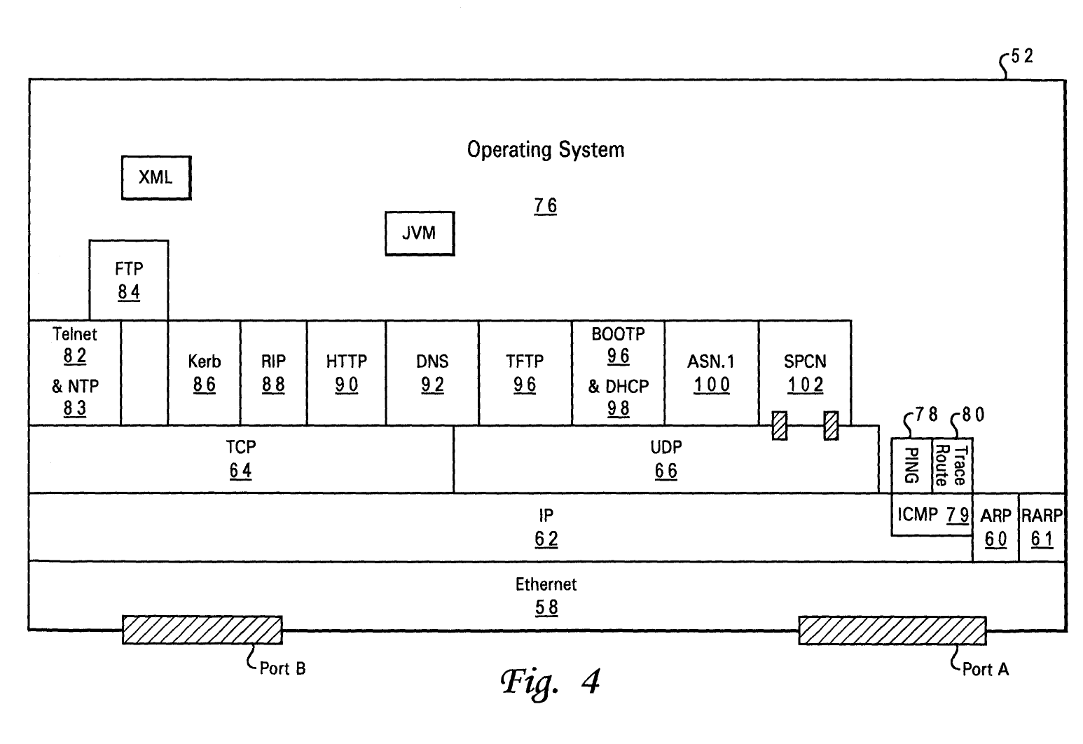

FIG. 4 illustrates additional detail for a TCP/IP stack for CES node 52. As schematically illustrated, port A and port B in a preferred embodiment are registered jacks-45 (RJ45). Ethernet software 58, as depicted, includes a logical link control (LLC) layer (not shown), a media access control (MAC) layer (not shown), and a physical layer (PHY) (not shown). The LLC layer controls frame synchronization, flow control and error checking. The MAC layer is responsible for moving data packets to and from one NIC to another between computers in the Ethernet. The PHY is hardware associated with each Ethernet transceiver and RJ45 jack.

In the layer above Ethernet software 58 is IP 62, as described earlier with FIG. 3. Also above Ethernet software 58 in the stack is address resolution protocol (ARP) 60, used to associate an IP address with a physical address. Additionally, a reverse address resolution protocol (RARP) software may be above Ethernet software 58, and is depicted in FIG. 4 as RARP 61. RARP 61 permits a physical Ethernet address to be translated into an IP address.

Above the IP layer are TCP 64 and UDP 66, as described earlier in FIG. 3. Above the TCP 64 or UDP 66 layer may be any standard application software. Such software may be Telnet 82, Network Time Protocol (NTP) 83, typical terminal emulation programs for TCP/IP networks such as Ethernets. Running the Telnet program allows a user on a personal computer (PC) to connect to one of the computers in the Ethernet, preferably master computer 44. The user is then able to enter commands through the Telnet program that are then executed on master computer 44, thus allowing remote access to the Ethernet and/or communication with other servers.

Another viable application program above the TCP 64 or UDP layer Kerberos 86. Kerberos 86 is an authentication system using encryption that enables two parties to exchange private information across an otherwise open network. Encrypted communication allows a remote user to log into the Ethernet network, similar to the protocol described for Telnet 82 and NTP 83. Other protocols that may be utilized are routing information protocol (RIP) 88, HyperText transfer protocol (HTTP) 90, trivial file transfer protocol (TFTP) 94, BootP 96 and DHCP 98. Other languages, such as abstract syntax notation one (ASN.1) 100, which defines the way data is sent across a similar communication systems, may be used. Similarly, domain, name, system (DNS) 92, an Internet service that translates domain names into IP addresses, may be used. As stated earlier, however, in a preferred embodiment SPCN 102 is utilized. Most of the application programs, protocols, and languages, especially Telnet 82 and NTP 83, also use file transfer protocol (FTP) 84 for sending files. Finally, at the top of the TCP/IP or UTP/IP stack is an embedded operating system 76, such as Linux, Unix, etc., which may utilize script such as extensible markup language (XML) and/or JAVA virtual machine, both platform independent scripts or programming languages that convert code into machine language and execute it.

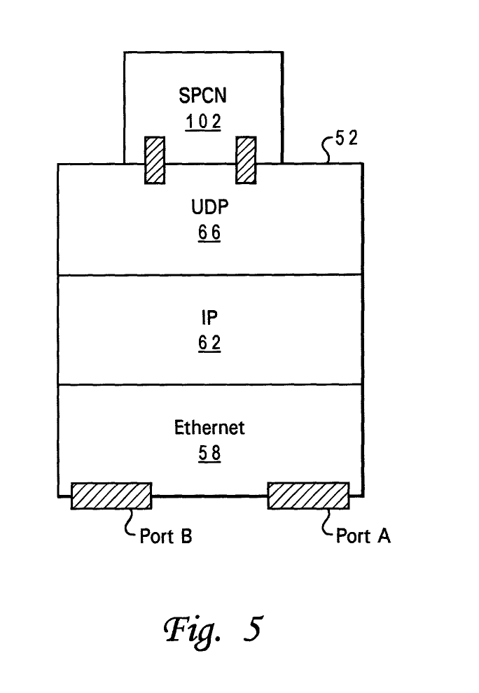

An alternate and less expensive embodiments of the present invention uses an inexpensive microprocessor, such as the 8-bit Intel 8051 with only approximately 30 kilobytes of code using a minimal UDP/IP stack and minimal CES functions (power and fan control), from control nodes 52. As illustrated in FIG. 5, port A and port B interface Ethernet software 58, on top of which are layers of IP 62 and UDP 66. Above UDP 66 is SPCN 102, which must define both the UDP port and IP socket. This configuration would not provide the same error checking provided by the TCP/IP configuration, but as explained later, in a string or ring topology, using a Master/Slave application protocol, such confirmation would not be necessary since failure to receive back the message at the master computer 44 would indicate a break in the string or ring topology.

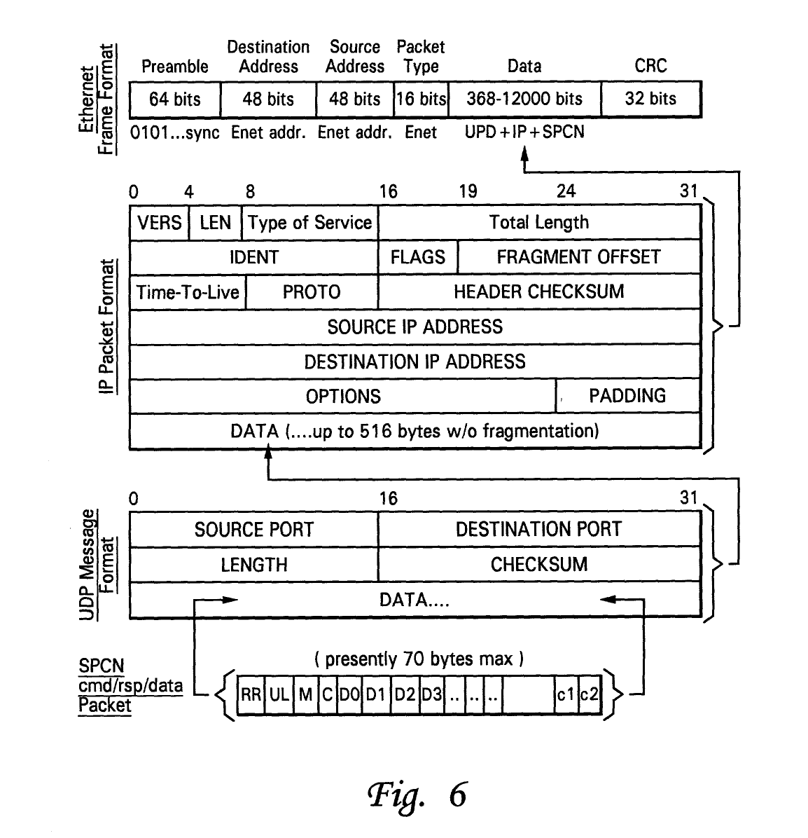

FIG. 6 illustrates a preferred embodiment of an SPCN command packet that is encapsulated in UDP and IP packets for transmission via the Ethernet framed topology. The Ethernet framed format includes the preamble, the destination address, source address, packet type identifying it as an Ethernet packet, the data itself, and the cyclic redundancy check (CRC) to detect data transmission errors. The data packet in the Ethernet format includes the UDP message format, the IP packet format, and the SPCN control code, which contains a copy of the source and destination IP addresses.

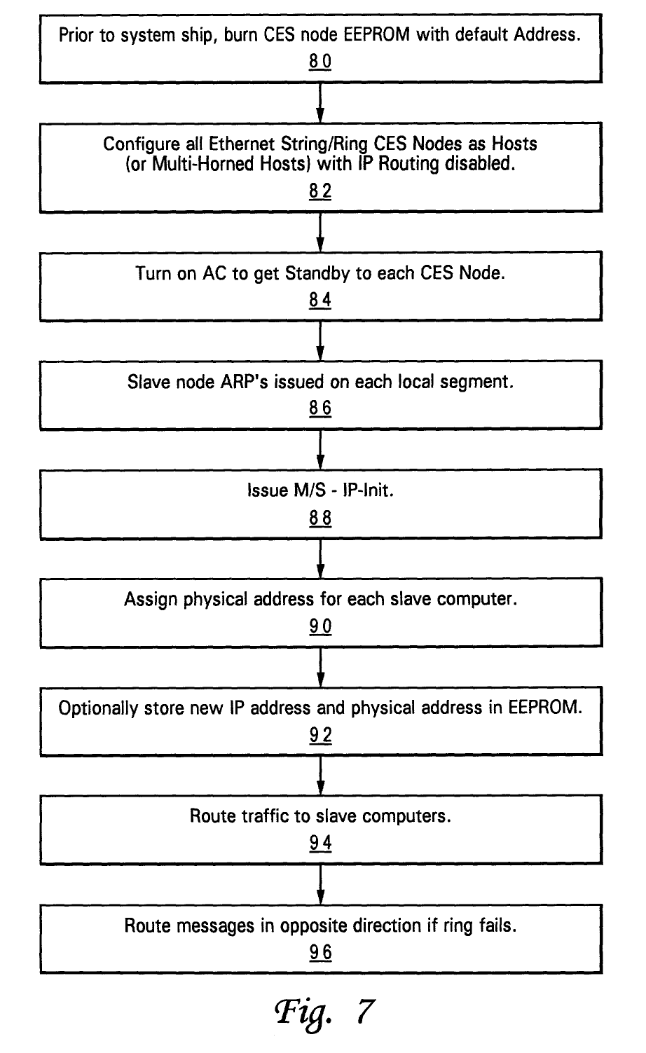

References now made to FIG. 7, there is illustrated a flow chart depicting a preferred embodiment for assigning new IP addresses in an Ethernet topology, preferably using the above described hardware and/or software packets. As referenced in block 80, prior to shipping the Ethernet network to the customer, the electrically erasable programmable read only memory (EEPROM) associated with each CES node 52, is programmed with a default IP address. As is customary in the art for Class-C addresses, the first three bytes of the IP address, each separated by a period, identify the network identification (net ID), while the last byte, also separated by a period, identifies the host identification (host ID). The net ID portion of the default IP address for each CES node 52 must be identical for all CES nodes 52. Preferably, the net ID should be a Class C IEEE private IP addressed base (192.168.1.X), or the assigned address base for the manufacturers or client corporation (e.g., IBM=9.X.X.X). Assigning net IDs that are either private or known will help prevent routing of IP packets should an ill advised connection be made directly to a public Ethernet, the Internet, or a local area network (LAN) used by the customer. Each node port is burned with a unique in the world MAC address dictated by IEEE standards at this stage.

As described in block 82, each CES node 52 in the Ethernet string/ring should be configured as a host (or a multi-homed host) with the IP routing function disabled. All configuration can be partially or completely programmed in the EEPROM of the CES nodes 52 prior to shipment of the system, or can be modified in the field through SPCN or non-SPCN protocols, or the CES nodes 52 can be configured partially in EEPROM and partially in the random access memory (RAM) (not shown) of each computer. By configuring each CES node 52 as a host or multi-homed host, master computer 44 is able to direct Ethernet broadcast or uni-cast packets to a port in a determined slave computer either through port A or port B of the master computer 44 during an initial program load (IPL) when all ports of the CES nodes 52 power up.

As illustrated in block 84, standby power (sometimes referred to as “auxiliary power) is applied to each of the computer's CES node 52. As depicted in block 86, each ARP in each slave CES node 52 is allowed to be issued on each local segment only. Independent ARP caches can be maintained on each slave CES node 52, with one ARP cache per port. The ARP caches, if used, can be a source for collection by the master CES node 52 to verify the association of a media access control (MAC) address to an IP address for each slave port.

As described in block 88, master computer 44 then issues a master/slave IP/initialization command. The command monitors for failures, and utilizes an alternate path when necessary. That is, if a response is not received from slave computer 48 as depicted in FIG. 3 due to a break between slave computer 46 and slave computer 48, then master computer 44 uses the reverse pathway out of port B of CES node 52 of master computer 44 to access slave computer 48. In an alternate preferred embodiment, the error information describing the break can be sent to a operating system and/or service connection, so that appropriate repairs can be made. An IP initialization (IP/Init) command may reassign multiple slave IP addresses for each CES node 52, or may issue a separate command for each CES node 52.

As described in block 90, the master computer 44 initiated IP-Init command assigns a physical address for each slave computer either as part of the original IP-Init command or in a separate command after the IP addresses have been assigned. As described in block 92, after the IP addresses have been assigned, the new IP addresses and physical addresses may optionally be stored in the EEPROM associated with each slave computer as well as master computer 44. This storage allows a history of the addresses used if power is removed from the slave or master computer, and the addresses can then be restored if desired.

As shown in block 94, once master computer 44 has re-assigned the CES node IP addresses at the slave computers, all traffic can be routed exclusively within the application layer, or the traffic may use IP Forwarding (i.e. IP Route Tables in the network), or a combination of the two. That is, each slave computer will contain logic (preferably through software) that says “If the message I am receiving contains my IP address, I consume it. If not, I forward the message to my other port for transmittal to the next computer in the network.” As illustrated in block 96, if all nodes in the network are configured in a Ring topology, and communication in one direction around the ring fails, then master computer 44 will send the packet messages in the alternate direction.

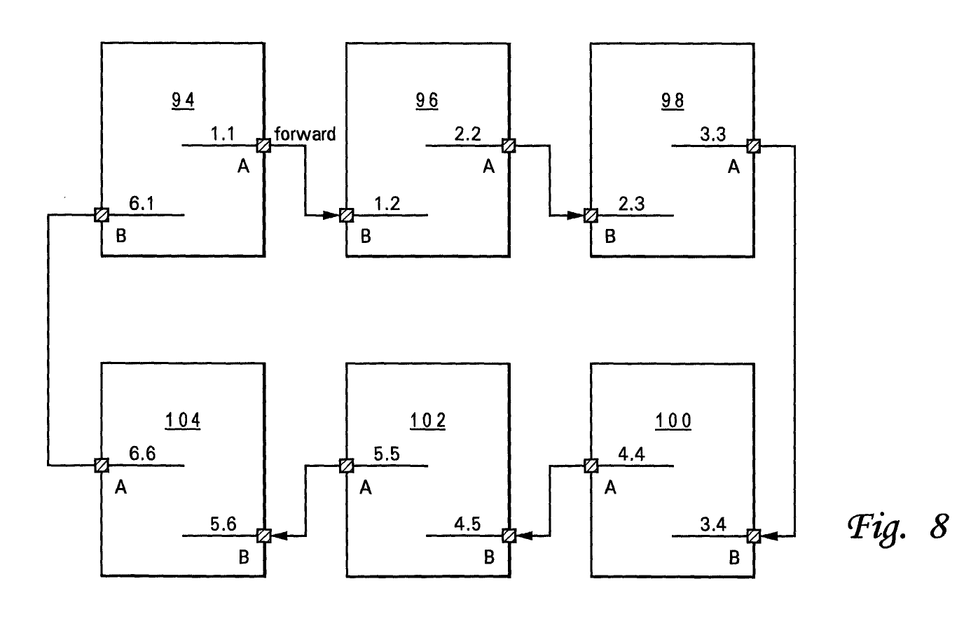

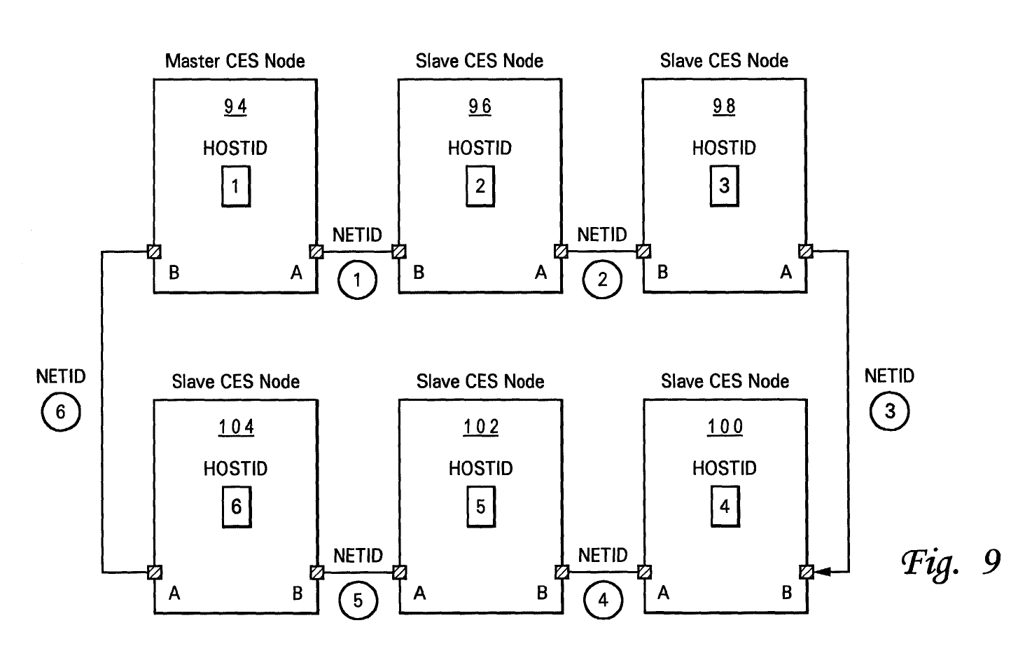

Referring now to FIG. 8, additional detail is shown when the operation is described in block 88 of FIG. 7. FIG. 8 illustrates an Ethernet topology having a master computer and five slave computers, each having a CES node. All of the slave CES nodes are initialized in manufacture with a default IP address as described in block 80 of FIG. 7. As an example, the IP address of each slave node at port A may be 192.168.1.252, while the IP address at port B of each slave CES node may be 192.168.1.253. Note that the net ID is the same for all slave CES node ports. After the IP addresses for all ports have been reassigned, preferably using SPCN, the port addresses for slave CES nodes 96, 98, 100, 102, and 104 are as depicted in FIG. 8. For example, the IP address for port A of slave CES node 96 is now 192.168.2.2 after being reassigned. The IP address for port B of slave CES node 96 is 192.168.1.2. In a preferred embodiment, the host ID identifies the particular computer, and the last byte in the net ID identifies the connecting computer. FIG. 9 reillustrates the configuration depicted in FIG. 8 with the host ID number and net ID last byte clearly labeled.

Below are examples of how the CES node IP route tables, for the first two CES nodes 52, may appear after each CES node 52 connection is reassigned a unique network ID. These tables, shown in an exemplary manner as Table I and Table II, may optionally be used if simple IP-forwarding is implemented in an alternate embodiment. IP-forwarding, if used, may be employed to bypass the application layers on intermediate host as described above, for performance reasons.

TABLE I

| | IP Route Tables | | | |
|---|---|---|---|---|
| CES Node# | destination | | | |
| HOST ID | network | flag | Gateway | Port |
| 1 | 192.168.1.2 | direct | 192.168.1.2 | A |
| 1 | 192.168.2.3 | indirect | 192.168.1.2 | A |
| 1 | 192.168.3.4 | indirect | 192.168.1.2 | A |
| 1 | 192.168.4.5 | indirect | 192.168.1.2 | A |
| 1 | 192.168.5.6 | indirect | 192.168.1.2 | A |
| 1 | 192.168.6.1 | indirect | 192.168.1.2 | A |
| 1 | 192.168.6.6 | direct | 192.168.6.6 | B |
| 1 | 192.168.5.5 | indirect | 192.168.6.6 | B |
| 1 | 192.168.4.4 | indirect | 192.168.6.6 | B |
| 1 | 192.168.3.3 | indirect | 192.168.6.6 | B |
| 1 | 192.168.2.2 | indirect | 192.168.6.6 | B |
| 1 | 192.168.1.1 | indirect | 192.168.6.6 | B |

TABLE II

| | IP Route Tables | | | |
|---|---|---|---|---|
| CES Node# | destination | | | |
| HOST ID | network | flag | Gateway | Port |
| 2 | 192.168.2.3 | direct | 192.168.2.3 | A |
| 2 | 192.168.3.4 | indirect | 192.168.2.3 | A |
| 2 | 192.168.4.5 | indirect | 192.168.2.3 | A |
| 2 | 192.168.5.6 | indirect | 192.168.2.3 | A |
| 2 | 192.168.6.1 | indirect | 192.168.2.3 | A |
| 2 | 192.168.1.2 | indirect | 192.168.2.3 | A |
| 2 | 192.168.6.6 | direct | 192.168.1.1 | B |
| 2 | 192.168.5.5 | indirect | 192.168.1.1 | B |
| 2 | 192.168.4.4 | indirect | 192.168.1.1 | B |
| 2 | 192.168.3.3 | indirect | 192.168.1.1 | B |
| 2 | 192.168.2.2 | indirect | 192.168.1.1 | B |
| 2 | 192.168.1.1 | indirect | 192.168.1.1 | B |
| ● | ● | ● | ● | ● |
| ● | ● | ● | ● | ● |
| ● | ● | ● | ● | ● |

Table III illustrates the contents of the ARP caches for the CES nodes 52. The ARP cache can be convenient memory for CES node 52 of master computer 44 to query to determine whether the current IP address to MAC correlation matches the expected results before and after address re-assignments.

TABLE III
ARP TABLE

| IP Address | Ethernet Address |
|---|---|
| Master Node Port B IP Address | Master Node Port B Ethernet Address |
| 192.168.6.1 | XX-XX-XX-XX-XX-XX |
| Master Node Port A IP Address | Master Node Port A Ethernet Address |
| 192.168.1.1 | XX-XX-XX-XX-XX-XX |
| Slave Node Port B IP Address | Slave (1) Port B Ethernet Address |
| 192.168.1.2 | XX-XX-XX-XX-XX-XX |
| Slave Node Port A IP Address | Slave (1) Port A Ethernet Address |
| 192.168.2.2 | XX-XX-XX-XX-XX-XX |
| ● | ● |
| ● | ● |
| ● | ● |
| Slave Node Port B IP Address | Slave (N) Port B Ethernet Address |
| 192.168.N-1.N | XX-XX-XX-XX-XX-XX |
| Slave Node Port A IP Address | Slave (N) Port A Ethernet Address |
| 192.168.N.N | XX-XX-XX-XX-XX-XX |

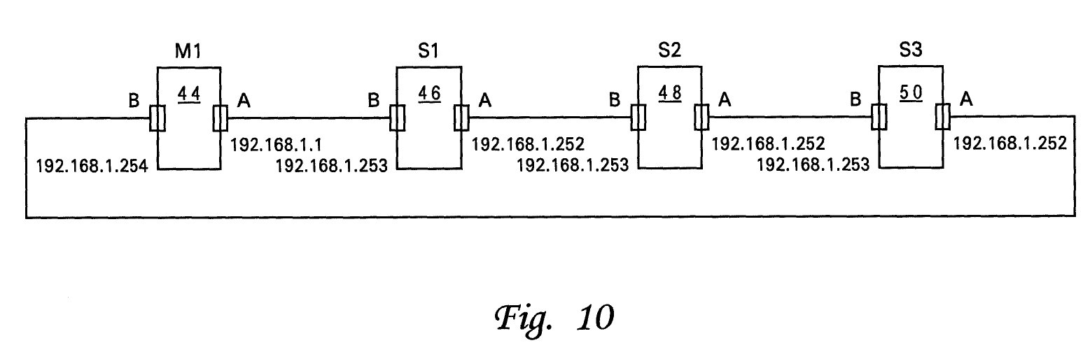

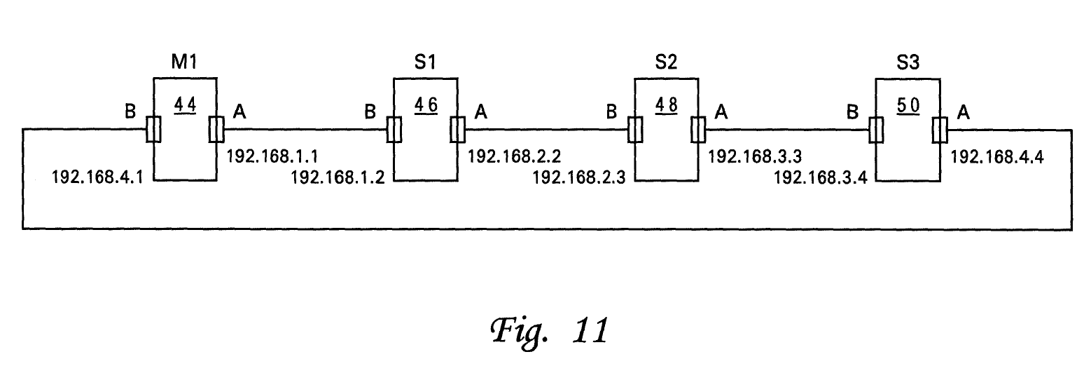

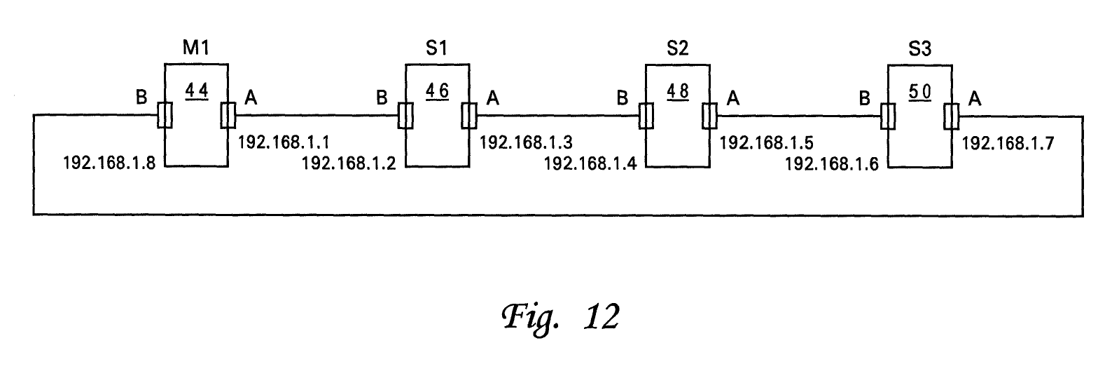

FIG. 10 depicts a four node Ethernet ring where the IP addresses from the ports of each CES node 52 (not shown in FIG. 10) have a factory set default before master computer 44 carries out the master/slave IP-Init process. All nodes are configured as hosts, and IP-forwarding is turned off. Port A, preferably as a UDP sending Port 65000, of master computer 44 sends out a uni-cast (or a network directed broadcast) packet to port B, preferably a UDP receiving Port 65003, of slave computer 46. This packet flows to the SPCN application found in slave computer 46, and contains an encapsulated SPCN command that instructs slave computer 46 to reassign the default port IP address. When this is finished, slave computer 46 replies back through slave computer 46's Port B, preferably a UDP sending Port 65002, to master computer 44, via master computer 44's Port A, preferably a UDP receiving Port 65001, with a “command-complete”. This process repeats itself for port A of slave computer 46, then port B of slave computer 48, port A of slave computer 48, etc. until all node IP addresses for each computer are reassigned as shown in FIG. 11 or FIG. 12. This process terminates with the reassignment of the master's own interface port B. The private UDP ports 65000-65003 can be reused for all SPCN commands and/or transmission control protocol (TCP) sockets can be used for all SPCN commands.

It should be appreciated that the method described above for assigning addresses can be embodied in a computer program product in a variety of forms, and that the present invention applies equally regardless of the particular type of signal bearing media utilized to actually carry out the method described in the invention. Examples of signal bearing media include, without limitation, recordable type media such as floppy disks or compact disk read only memories (CD ROMS) and transmission type media such as analog or digital communication links.

While the invention has been particularly shown and described with reference to a preferred embodiment, it will be understood by those skilled in the art that various changes in form and detail may be made therein without departing from the spirit and scope of the invention.

What is claimed is:

1. A method for assigning Internet Protocol addresses in a computer network, said method comprising:
connecting in the computer network a master computer to a slave computer;
assigning by said master computer a physical address to said slave computers; and
assigning by said master computer a unique Internet Protocol (IP) address to said slave computer such that said master computer manages the IP address assignment of said slave computer.

2. The method of claim 1, wherein said master computer initiates all communications between said master computer and said slave computer.

3. The method of claim 1, further comprising connecting said master computer and said slave computer in an Ethernet string topology.

4. The method of claim 1, further comprising connecting said master computer and said slave computer in an Ethernet ring topology.

5. The method of claim 1, further comprising transmitting a signal between said master computer and said slave computer by selectively directing said signal to either a transmission control protocol (TCP) socket or a user datagram protocol (UDP) port on said master computer and said slave computer.

6. The method of claim 1, further comprising:
connecting an intermediate slave computer between said master computer and said slave computer, said intermediate slave computer comprising a software application layer hierarchically above an Ethernet software layer; and
bypassing said application layer in said intermediate slave computer when sending a signal to a subsequent slave computer by enabling a forwarding command in said Ethernet software layer when said signal is not addressed to said intermediate slave computer.

7. The method of claim 1, further comprising storing said IP address in an Address Resolution Protocol (ARP) table in said master computer.

8. A network having a master computer and at least one slave computer, said network comprising:
means for connecting the master computer and the at least one slave computer;
means for assigning by the master computer a physical address to each of said at least one slave computer; and
means for assigning by the master computer a unique Internet Protocol (IP) address to each of said at least one slave computers.

9. The network of claim 8, wherein the master computer initiates all communications between the master computer and said at least one slave computer.

10. The network of claim 8, further comprising means for connecting the master computer and the at least one slave computer in an Ethernet string topology.

11. The network of claim 8, further comprising means for connecting the master computer and the at least one slave computer in an Ethernet ring topology.

12. The network of claim 8, further comprising means for transmitting a signal between the master computer and the at least one slave computer by selectively directing said signal to either a transmission control protocol (TCP) socket or a user datagram protocol (UDP) port on the master computer and the at least one slave computer.

13. The network of claim 8, further comprising:
means for connecting an intermediate slave computer between the master computer and the at least one slave computer, said intermediate slave computer comprising a software application layer hierarchically above an Ethernet software layer; and
bypassing said application layer in said intermediate slave computer when sending a signal to a subsequent slave computer by enabling a forwarding command in said Ethernet software layer when said signal is not addressed to said intermediate slave computer.

14. The network of claim 8, further comprising means for storing said unique IP address in an Address Resolution Protocol (ARP) table in the master computer.

15. A computer usable medium comprising:
computer program code within said computer usable medium, said computer program code being capable of being used to assign Internet Protocol addresses in a computer network, said computer program code including:
instructions for connecting in the network a master computer to at least one slave computer;
instructions for assigning by said master computer a physical address to each of said at least one slave computers; and
instructions for assigning by said master computer a unique Internet Protocol (IP) address to each of said at least one slave computers.

16. The computer usable medium of claim 15, further comprising computer program code for said master computer to initiate all communications between said master computer and said at least one slave computer.

17. The computer usable medium of claim 15, further comprising computer program code enabling said master computer and said at least one slave computer to communicate in an Ethernet ring topology.

18. The computer usable medium of claim 15, further comprising computer program code for transmitting a signal between said master computer and said at least one slave computer by selectively directing said signal to either a transmission control protocol (TCP) socket or a user datagram protocol (UDP) port on said master computer and said at least one slave computer.

19. The computer usable medium of claim 15, further comprising:
computer program code for connecting an intermediate slave computer between said master computer and said at least one slave computer, said intermediate slave computer comprising a software application layer hierarchically above an Ethernet software layer; and
computer program code for bypassing said application layer in said intermediate slave computer when sending a signal to a subsequent slave computer by enabling a forwarding command in said Ethernet software layer when said signal is not addressed to said intermediate slave computer.

20. The computer usable medium of claim 15, further comprising computer program code for storing said IP address in an Address Resolution Protocol (ARP) table in said master computer.
